(19) United States
(12) Patent Application Publication
(10) Pub. No.: US 2016/0187924 A1
(43) Pub. Date: Jun. 30, 2016

(54) ELECTRONIC DEVICE ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YONG-CHANG FAN, Wuhan (CN); SAN-YONG YANG, Wuhan (CN)

(21) Appl. No.: 14/600,853

(22) Filed: Jan. 20, 2015

(30) Foreign Application Priority Data
Dec. 29, 2014 (CN) 201410832759.6

(51) Int. Cl. G06F 1/16

(52) U.S. Cl. CPC G06F 1/1624; G06F 1/1679; G06F 1/1626

(57) ABSTRACT

Electronic device assembly includes a first electronic device and a second electronic device moveably received in the first electronic device. The first electronic device includes a controller. The second electronic device includes a connecting module. When the second electronic device is received in the first electronic device, the connecting module is connected to the controller; thereby the controller is configured to control the second electronic device to display on the first electronic device.

### FIELD

The subject matter herein generally relates to an electronic device assembly that includes a tablet computer and a mobile phone.

### BACKGROUND

Electronic devices, such as tablet computers and mobile phones, are popular. A tablet computer often has a slim exterior and can be used to play music, view pictures, and play games. A mobile phone often has a thicker exterior than that of the tablet computer, and can be used as a telephone and a camera as well as play music, view pictures, and play games. The tablet computer and the mobile phone are usually used separately.

### BRIEF DESCRIPTION OF THE DRAWINGS

Implementations of the present technology will now be described, by way of example only, with reference to the attached figures.

FIG. 1 is an exploded, isometric view of an embodiment of an electronic device assembly.

FIG. 2 is an enlarged view of a circled portion II of FIG. 1.

FIG. 3 is a first assembled view of the electronic device assembly of FIG. 1, a receiving tray extends out of a first electronic device, and a second electronic device is not received in the receiving tray.

FIG. 4 is similar to FIG. 3, the receiving tray extends out of the first electronic device, and the second electronic device is received in the receiving tray.

FIG. 5 is a second assembled view of the electronic device assembly of FIG. 1, and the receiving tray and the second electronic device are received in the first electronic device.

FIG. 6 is similar to FIG. 5, where a cover is placed on a main body of the first electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an electronic device assembly. The electronic device assembly includes a first electronic device and a second electronic device moveably received in the first electronic device. The first electronic device includes a controller. The second electronic device includes a connecting module. When the second electronic device is received in the first electronic device, the connecting module is connected to the controller; thereby the controller is configured to control the second electronic device for displaying by the first electronic device.

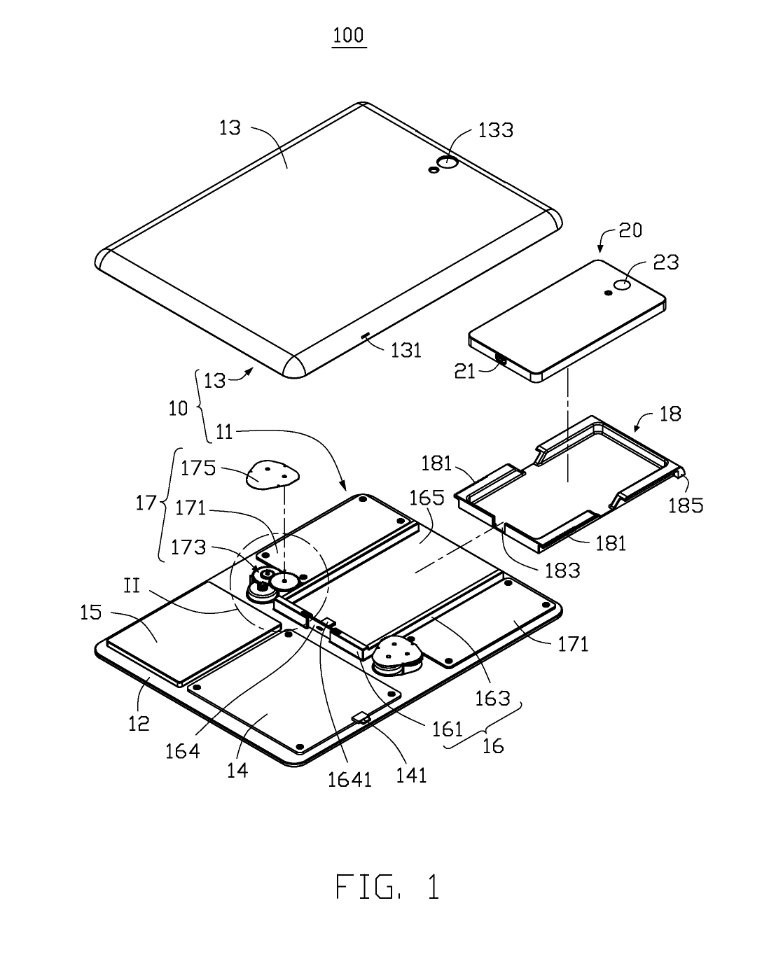

FIG. 1 illustrates an embodiment of an electronic device assembly 100. The electronic device assembly 100 includes a first electronic device 10 and a second electronic device 20 configured to be moveably attached to the first electronic device 10. In at least one embodiment, the first electronic device 10 is a tablet computer which has a low configuration and can be used to play music, display pictures and play games, and the second electronic device 20 can be a mobile phone which has a higher configuration than that of the first electronic device 10.

The first electronic device 10 includes a main body 11 and a cover 13 configured to cover the main body 11. The main body 11 includes a base 12, a controller 14, a power supply 15, a receiving portion 16, two driving modules 17 arranged at opposite sides of the receiving portion 16, and a receiving tray 18 slidably attached to the receiving portion 16.

The controller 14 is coupled to the driving module 17 to allow the driving module 17 to move the receiving tray 18 in a first direction that is substantially parallel to the base 12 and out of the first electronic device 10. A button 141 is located on an edge of the controller 14 and is configured to send a signal to the controller 14; thereby the controller 14 can control the driving module 17 according to the signal.

The power supply 15 is located beside of the controller 14. In at least one embodiment, the power supply 15 can supply power for the first electronic device 10 when the second electronic device 20 is separated from the first electronic device 10, and the power supply 15 also can supply power for the first electronic device 10 and the second electronic device 20 when the second electronic device 20 is coupled to the first electronic device 10.

The receiving portion 16 includes an end portion 161 and two side portions 163 extending from opposite edges of the end portion 161. Each side portion 163 is substantially perpendicular to the end portion 161 and the base 12. A circuit board 164 is located on the end portion 161 and electronically coupled to the controller 14. A connector 1641 is set on the circuit board 164. The end portion 161 and the two side portions 163 cooperatively define a receiving space 165 for receiving the receiving tray 18.

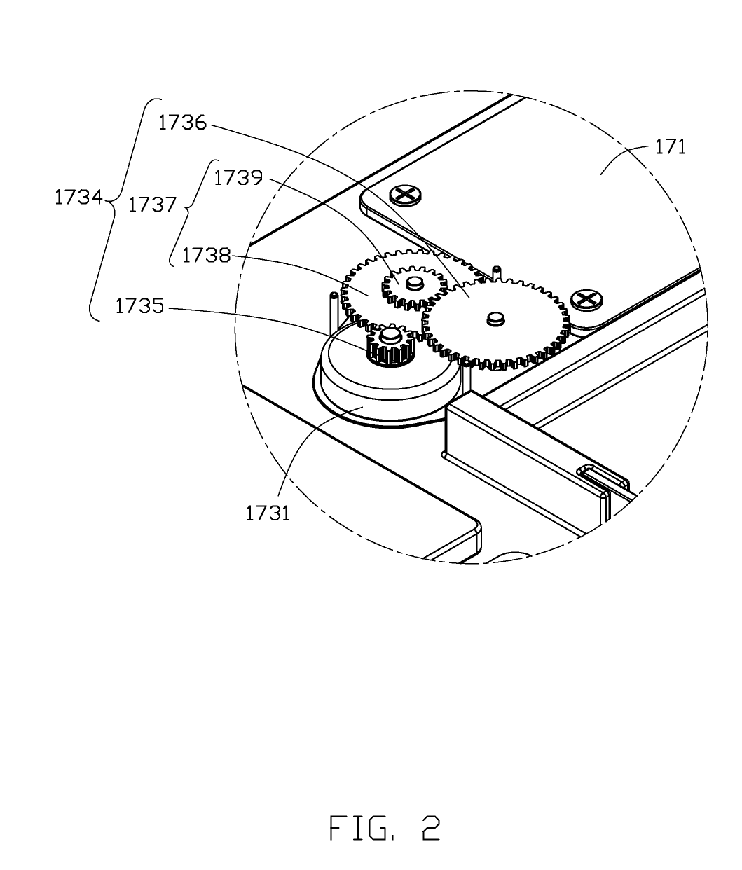

FIGS. 1 and 2 illustrate an embodiment of the driving module 17 of the electronic device assembly 100. Each driving module 17 includes a driving plate 171 coupled to the controller 14, a driver 173 coupled to the driving plate 171, and a shielding plate 175 covering the driver 173. The driving plate 171 can be controlled by the controller 14 to rotate the driver 173 clockwise for allowing the receiving tray 18 to move out of the first electronic device 10. The driver 173 includes a motor 1731 and a gear assembly 1734 controlled by the motor 1731. The gear assembly 1734 includes a master gear 1735 secured to the motor 1731, a slave gear 1736, and an intermediate gear 1737 meshing with the master gear 1735 and the slave gear 1736. In at least one embodiment, the intermediate gear 1737 includes a first portion 1738 and a second portion 1739 which has a diameter less than the first portion 1738. The first portion 1738 meshes with the master gear 1735 and the second portion 1739 meshes with the slave gear 1736. The motor 1731 can rotate the gear assembly 1734 clockwise when receiving the signal from the controller 14. When the gear assembly 1734 is rotated counterclockwise by force, the motor 1731 can rotate the gear assembly 1734 counterclockwise.

The receiving tray 18 is configured to receive the second electronic device 20, and two gear racks 181 are located on opposite sides of the receiving tray 18. A cutout 183 is defined in a first end of the receiving tray 18, and a handle 185 is located on a second end of the receiving tray 18.

The cover 13 defines a slot 131 configured to be exposed and a through hole 133.

The second electronic device 20 includes a connecting module 21. The connecting module 21 can be coupled to the connector 16, so that the controller 14 can control to the second electronic device 20 to display on the display (not shown) of the first electronic device 20. In at least one embodiment, the second electronic device 20 includes a detecting module (not shown). The detecting module can send a control signal to the controller 14 when detecting the connecting module 21 is coupled to the connector 1641, so that the controller 14 can control the second electronic device 20. The second electronic device 20 includes a camera 23. When the second electronic device 20 is received in the first electronic device 10, the camera 23 can be exposed by the through hole 133.

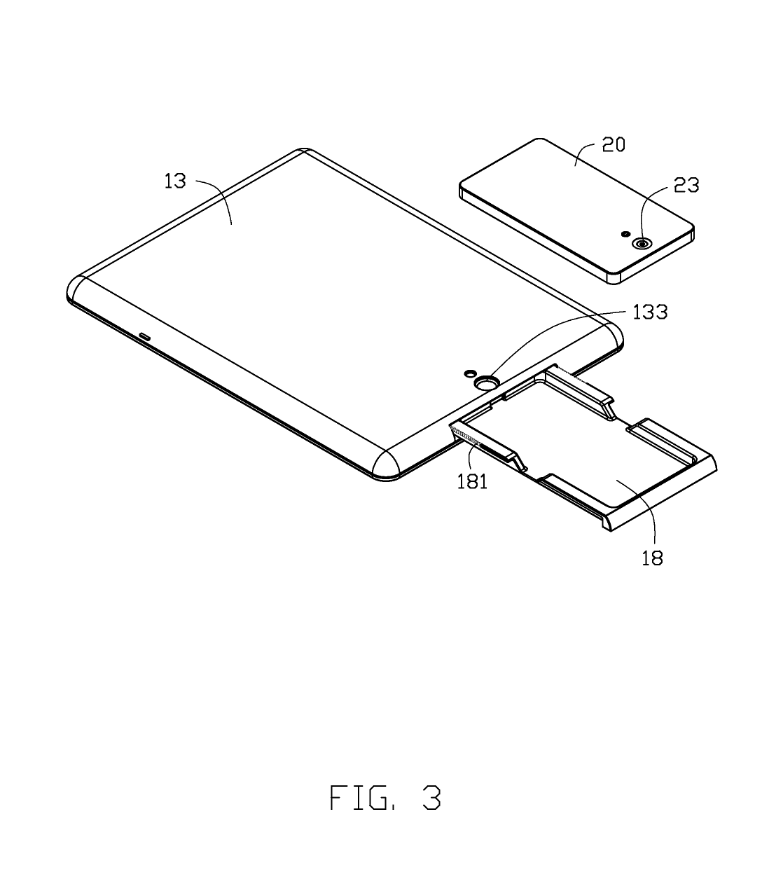

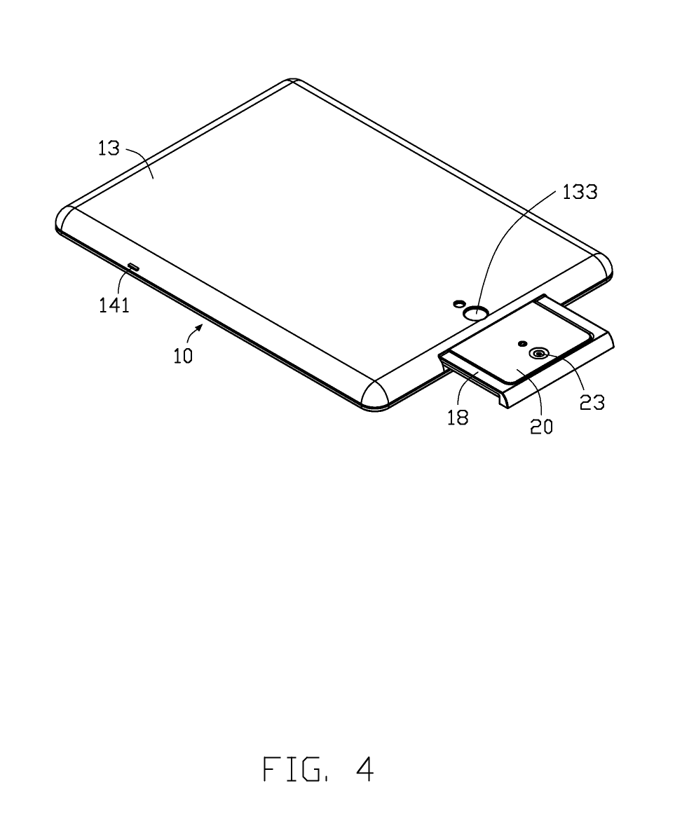

FIGS. 3 and 4 illustrate an embodiment of the electronic device assembly 100 in assembly. The shielding plate 175 is secured to the driver 173. The receiving tray 18 is received in the receiving space 165, and the gear rack 181 meshes with the slave gear 1736. The cover 13 is secured to the main body 11, so that the first electronic device 10 is assembled.

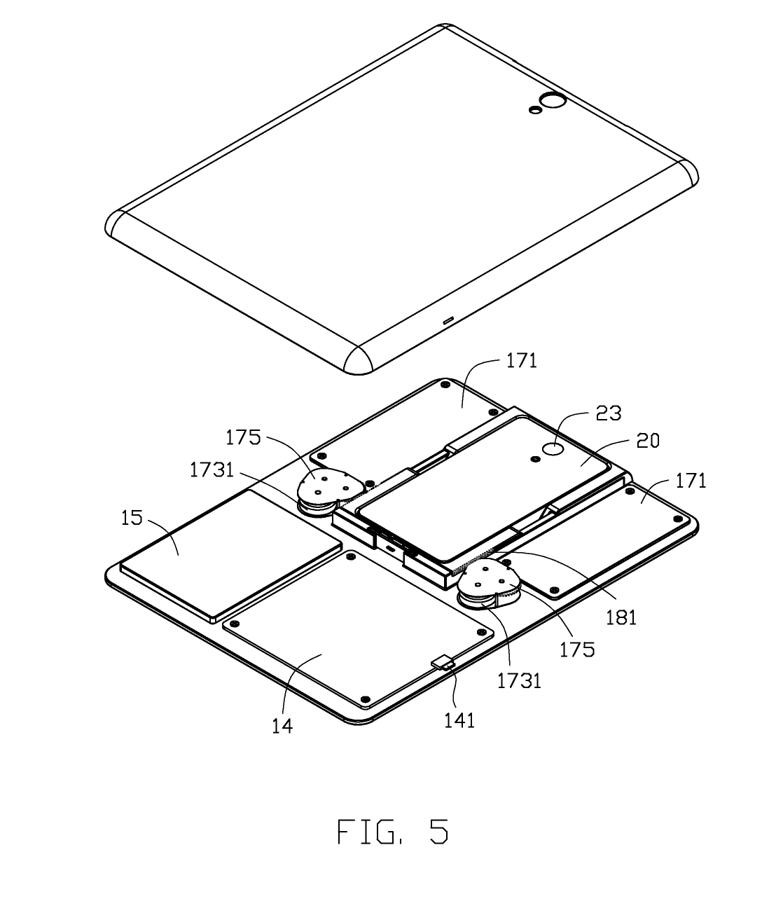

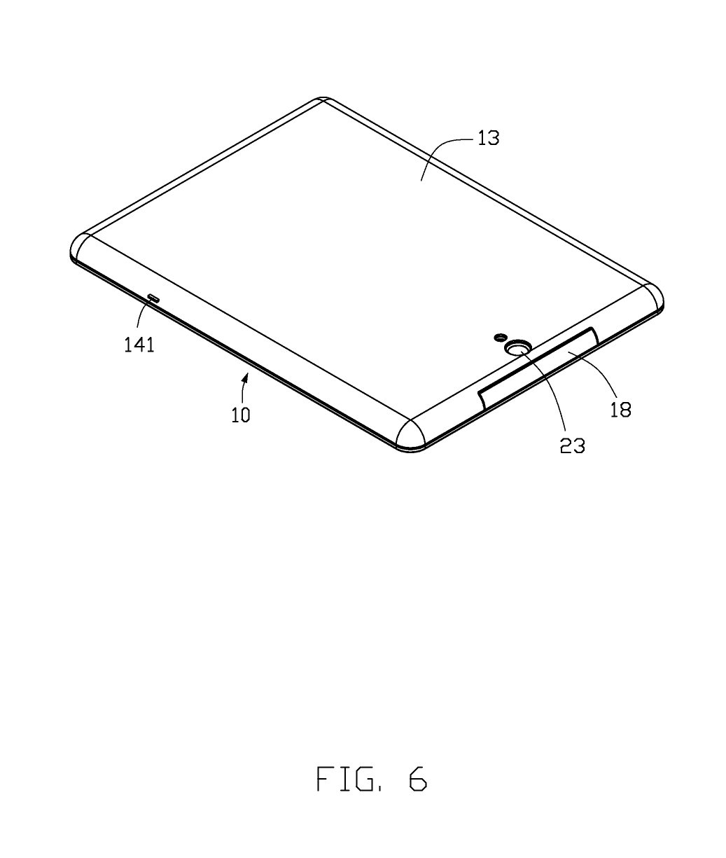

FIGS. 5 and 6 illustrate an embodiment of the first electronic device 10 or the second electronic device 20 being used alone. When the first electronic device 10 or the second electronic device 20 is used alone, the receiving tray 18 is received in the receiving portion 16. The first electronic device 10 can play music or display pictures and play games, and the second electronic device 20 can be a mobile phone which can make telephone calls and take photos.

FIGS. 3 and 4 further illustrate the second electronic device 20 is coupled to and received in the first electronic device 10. The button 141 is pressed to send a signal to the controller 14. The controller 14 receives the signal to control the driving plate 16 to start the driving module 17. The motor 171 of the driving module 17 rotates the gear assembly 173 clockwise to move the receiving tray 18 which meshes with the slave gear 1736 in the first direction. When the gear rack 181 of the receiving tray 18 is disengaged from the slave gear 1736, the receiving tray 18 is further moved in the first direction by the handle 185, until the receiving tray 18 is out of the first electronic device 10. At this position, the driving module 17 is waiting for the receiving tray 18.

The second electronic device 20 is received in the receiving tray 18. The receiving tray 18 is pulled by the handle 185 in a second direction opposite to the first direction. When the gear rack 181 meshes with the slave gear 1736, the gear rack 181 rotates the slave gear 1736 counterclockwise. Therefore, the motor 1731 can continue to rotate the slave gear 1736 counterclockwise, and the receiving tray 18 with the second electronic device 20 can be moved back to the receiving portion 16. When the connecting module 21 is engaged with the connector 16, the detecting module of the second electronic device 20 detects the engagement and sends a controlled signal to the controller 14 for allowing the controller 14 to control the second electronic device 20. Therefore, the display (not shown) of the second electronic device 20 cannot work, and the functions of the second electronic device 20 can be displayed on the display of the first electronic device 10. The camera 23 is exposed by the through hole 133, so that the first electronic device 10 can take photos via the second electronic device 10. In other words, the electronic device assembly 100 is an assembly of the first electronic device 10 and the second electronic device 20, the first electronic device 10 can make telephone calls and take photos using a processer (not shown) of the second electronic device 20. An operation interface of the second electronic device 20 can be increased by the first electronic device 10. The power supply 15 can offer power for the first electronic device 10 and the second electronic device 20.

The embodiments shown and described above are only examples. Many details are often found in the art such as the other features of an electronic device assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device assembly comprising:
a first electronic device comprising a controller; and
a second electronic device comprising a connecting module;
wherein the second electronic device is moveably received in the first electronic device, the connecting module is connected to the controller, thereby the controller is configured to control the second electronic device for displaying by the first electronic device.

2. The electronic device assembly of claim 1, wherein the first electronic device further comprises a driving module coupled to the controller and a receiving tray moveably attached to the driving module, and the driving module is configured to be controlled by the controller to move the receiving tray in a first direction for allowing the second electronic device to receive in the receiving tray.

3. The electronic device assembly of claim 2, wherein the first electronic device further comprises a receiving portion for receiving the receiving tray, a connector coupled to the controller is located on the receiving portion, and the connecting module is coupled to the controller via connecting the connector.

4. The electronic device assembly of claim 2, wherein a button is located on the controller and is exposed out of the first electronic device, and the controller is configured to receive a signal of the button to control the driving module to move the receiving tray.

5. The electronic device assembly of claim 2, wherein the driving module comprises a driving plate coupled to the controller and a driver coupled to the driving plate, and the driving plate is controlled by the controller to rotate the driver in clockwise for allowing the receiving tray to move in the first direction.

6. The electronic device assembly of claim 5, wherein the receiving tray comprises a gear rack, the driver comprises a motor and a gear assembly meshing with the gear rack, and the motor is configured to rotate the gear assembly to move the receiving tray in the first direction.

7. The electronic device assembly of claim 6, wherein the gear assembly comprises a master gear coupled to the gear, an intermediate gear meshing with the master gear and a slave gear meshing with the intermediate gear, and the slave gear meshes with the gear rack.

8. The electronic device assembly of claim 7, wherein the intermediate gear comprises a first portion and a second portion which having a less diameter than the first portion, the first portion meshes with the master gear, and the second portion meshes with the slave gear.

9. The electronic device assembly of claim 1, wherein the first electronic device further comprises a power supply for supply power for the first electronic device, when the second electronic device is coupled to the first electronic device, the power supply is configured to offer power for the first electronic device and the second electronic device.

10. The electronic device assembly of claim 1, wherein the first electronic device is a tablet computer, and the second electronic device is a mobile phone.

11. An electronic device assembly comprising:
a first electronic device comprising a controller, a driving module coupled to the controller and a receiving tray moveably attached to the driving module; and
a second electronic device moveably received in the receiving tray and comprising a connecting module;
wherein the driving module is configured to be controlled by the controller to move the receiving tray out of the first electronic device for allowing the second electronic device to receive in the receiving tray; and
wherein when the second electronic device is received in the receiving tray, the connecting module is connected to the controller, thereby the controller is configured to control the second electronic device for displaying by the first electronic device.

12. The electronic device assembly of claim 11, wherein the first electronic device further comprises a base for securing the controller, the driving module and the receiving tray, and the receiving tray is moveable in a first direction that is substantially parallel to the base.

13. The electronic device assembly of claim 11, wherein the first electronic device further comprises a receiving portion for receiving the receiving tray, a connector coupled to the controller is located on the receiving portion, and the connecting module is coupled to the controller via connecting the connector.

14. The electronic device assembly of claim 11, wherein a button is located on the controller and is exposed out of the first electronic device, and the controller is configured to receive a signal of the button to control the driving module to move the receiving tray.

15. The electronic device assembly of claim 12, wherein the driving module comprises a driving plate coupled to the controller and a driver coupled to the driving plate, and the driving plate is controlled by the controller to rotate the driver in clockwise for allowing the receiving tray to move in the first direction.

16. The electronic device assembly of claim 15, wherein the receiving tray comprises a gear rack, the driver comprises a motor and a gear assembly meshing with the gear rack, and the motor is configured to rotate the gear assembly to move the receiving tray in the first direction.

17. The electronic device assembly of claim 16, wherein the gear assembly comprises a master gear coupled to the gear, an intermediate gear meshing with the master gear and a slave gear meshing with the intermediate gear, and the slave gear meshes with the gear rack.

18. The electronic device assembly of claim 17, wherein the intermediate gear comprises a first portion and a second portion which having a less diameter than the first portion, the first portion meshes with the master gear, and the second portion meshes with the slave gear.

19. The electronic device assembly of claim 11, wherein the first electronic device further comprises a power supply for supply power for the first electronic device, when the second electronic device is coupled to the first electronic device, the power supply is configured to offer power for the first electronic device and the second electronic device.

20. The electronic device assembly of claim 11, wherein the first electronic device is a tablet computer, and the second electronic device is a mobile phone.
